(19) United States
(12) Patent Application Publication
(10) Pub. No.: US 2011/0133510 A1
(43) Pub. Date: Jun. 9, 2011

(54) SATURATION-BASED SHADE-LINE DETECTION

(75) Inventor: Wende Zhang, Shelby Township, MI (US)

(73) Assignee: GM GLOBAL TECHNOLOGY OPERATIONS, INC., Detroit, MI (US)

(21) Appl. No.: 12/632,544

(22) Filed: Dec. 7, 2009

(51) Int. Cl. B60J 3/02; G06K 9/00; H04N 5/202

(52) U.S. Cl. 296/97.4; 382/168; 348/254; 348/E05.074

(57) ABSTRACT

A system and method for detecting a sun-shade line on a vehicle driver's face so as to automatically position a sun blocker at the appropriate location to block the sun. The method includes providing a detected image of the vehicle driver using, for example, a camera. A saturation analysis is performed on the detected image to generate a saturation image that includes bright dots and dark dots as a binary image. The method then performs a region enhancement of the saturation image to filter the saturation image. A histogram analysis is performed on the filtered saturation image to generate a graph that identifies a count of the bright dots in the image on a row-by-row basis. The method then performs a sharp change analysis on the graph to identify the largest transition from a row with the most dark dots to a row with the most bright dots to identify the sun-shade line.

### BACKGROUND OF THE INVENTION

1. Field of the Invention

This invention relates generally to a system and method for detecting a sun-shade line on an object and, more particularly, to a system and method for detecting a sun-shade line on a vehicle driver using a saturation-based detection process.

2. Discussion of the Related Art

Most vehicles are equipped with a sun visor that can be selectively flipped down from a stored position if the vehicle is traveling into a low sun angle so that the driver is not staring directly into the sun. The sun visor is typically able to block the sun shining through the windshield, as well as through the vehicle windows. The sun visor makes the driving experience more pleasant, and also has an obvious safety value.

Systems have been developed in the art for automatically adjusting the position of a sun blocker in response to changes in a sun incident angle. For example, U.S. Pat. No. 6,811,201, titled, Automatic Sun Visor and Solar Shade System for Vehicles, issued Nov. 2, 2004 to Naik, discloses an automatic sun visor system for a vehicle that includes a light detecting apparatus for detecting sunlight incident on the face of an occupant of the vehicle. The system includes a microcontroller that adjusts the sun visor in response to the detected sunlight on the face of the vehicle driver.

Other systems known in the art that automatically adjust the position of a vehicle sun blocker use GPS measurements to determine the location and orientation of the vehicle and sun maps to determine the position of the sun at a particular time of day. By knowing the position and orientation of the vehicle and the position of the sun, a controller can position the sun blocker at the proper location where it is between the vehicle driver's eyes and the sun.

Typically, the known GPS-based systems that attempt to automatically control the position of the sun blocker do not take into consideration the location of the vehicle driver's head, and thus drivers of different heights or who make different motions will typically not receive the full benefit of the position of the sun visor that was intended. These known systems are typically passive in nature in that they did not employ feedback to know whether the sun blocker was properly blocking the sun. Thus, it would desirable to provide an active sun visor system that detected a sun-shade line on the vehicle driver and positioned a sun blocker in response thereto where the system monitored the position of the sun-shade line as the driver and sun blocker move.

U.S. patent application Ser. No. 12/432,573, filed Apr. 29, 2009, titled Active Face Shade Detection in Auto Sun-Shade System, assigned to the assignee of this application and herein incorporated by reference, discloses an active system and method for detecting a sun-shade line on a vehicle driver using a low cost camera to control the position of a sun blocker. The method includes generating sequential images of the vehicle driver using the camera and providing a difference image from subsequent camera images to eliminate stationary parts of the image. The method then filters the difference image to enhance the expected motion from the controlled sun blocker and to remove the un-expected motion, such as from the vehicle driver in the horizontal direction, which generates a filter response image that includes an identification of the movement of the sun-shade line from image to image. The method then applies a threshold to the filter response image to remove portions of the filter response image that do not exceed a predetermined intensity, and performs a Hough transform on the threshold filter response image to identify the sun-shade line on the driver.

### SUMMARY OF THE INVENTION

In accordance with the teachings of the present invention, a system and method are disclosed for detecting a sun-shade line on a vehicle driver's face so as to automatically position a sun blocker at the appropriate location to block the sun. The method includes providing a detected image of the vehicle driver using, for example, a camera. A saturation analysis is performed on the detected image to generate a saturation image that includes bright dots and dark dots as a binary image. The method then performs a region enhancement of the saturation image to filter the saturation image. A histogram analysis is performed on the filtered saturation image to generate a graph that identifies a count of the bright dots in the image on a row-by-row basis. The method then performs a sharp change analysis on the graph to identify the largest transition from a row with the most dark dots to a row with the most bright dots to identify the sun-shade line.

Additional features of the present invention will become apparent from the following description and appended claims, taken in conjunction with the accompanying drawings.

### BRIEF DESCRIPTION OF THE DRAWINGS

FIG. 1 is an illustration of a system for automatically positioning a sun blocker in a vehicle;

FIG. 2 is a flow chart diagram showing a process for identifying a sun-shade line on the vehicle driver for the system shown in FIG. 1 using an active detection method;

FIG. 3 is a graph showing parameters for a Hough transform in the image domain;

FIG. 4 is a graph showing the parameters in FIG. 3 in the Hough domain;

FIG. 5 is a flow chart diagram showing a process for identifying a sun-shade line on the vehicle driver for the system shown in FIG. 1 using a saturation-based method;

FIG. 6 is a graph showing a histogram analysis of an image in the process shown in FIG. 5; and

FIG. 7 is a graph showing a sharp change analysis of the histogram analysis shown in FIG. 6.

### DETAILED DESCRIPTION OF THE EMBODIMENTS

The following discussion of the embodiments of the invention directed to a system and method for identifying a sun-shade line on a vehicle driver using a saturation-based method and automatically positioning a sun blocker in response thereto is merely exemplary in nature, and is in no way intended to limit the invention or its applications or uses. For example, the present invention has specific application for positioning a sun blocker in a vehicle. However, as will be appreciated by those skilled in the art, the invention may have applications in other environments for detecting a sun-shade line.

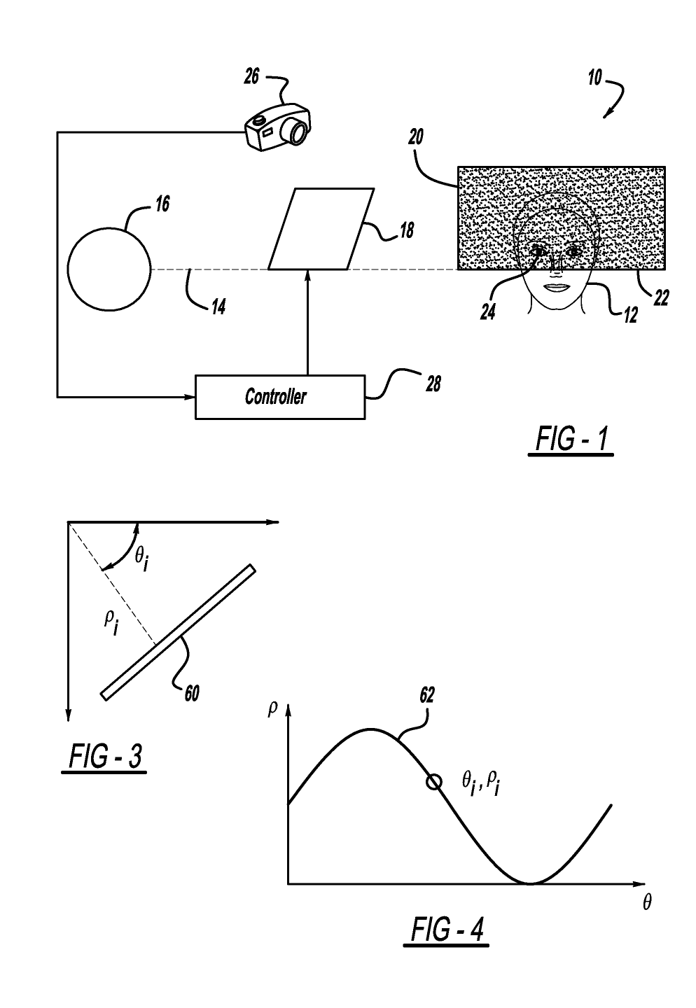

FIG. 1 is an illustration of a system 10 for detecting a sun-shade line on an object 12, such as a vehicle driver. The term sun-shade line as used herein is intended to mean any shade line formed by a light source. A light ray 14 from a light source 16, such as the sun, is directed towards the vehicle driver 12, such as through the vehicle windshield or side window. A sun blocker 18 is positioned between the light source 16 and the driver 12 within the vehicle and causes a shadow 20 to be formed. The blocker 18 that forms the shadow 20 can be any blocker that is suitable for the purposes described herein. In one specific embodiment, the blocker 18 is part of the vehicle windshield or side windows, referred to in the industry as “smart glass.” For example, the smart glass can include electro-chromic portions in the windshield or side window that are responsive to electric signals that cause the electro-chromic portions to become opaque. The shadow 20 causes a sun-shade line 22 to be formed on the face of the driver 12, where it is desirable to maintain the blocker 18 in a position where eyes 24 of the driver 12 are within the shadow 20.

A camera 26 takes images of the driver 12 and sends those images to a controller 28. The camera 26 can be any camera suitable for the purposes described herein, including low cost cameras. The controller 28 filters out noise as a result of motion of the driver 12 from frame-to-frame in the images generated so as to identify the sun-shade line 22 to make sure it is at the proper location as the driver 12 and the blocker 18 move. As the driver 12 moves and the light source 16 moves, the controller 28 automatically positions the blocker 18 to provide the shadow 20 at the proper location.

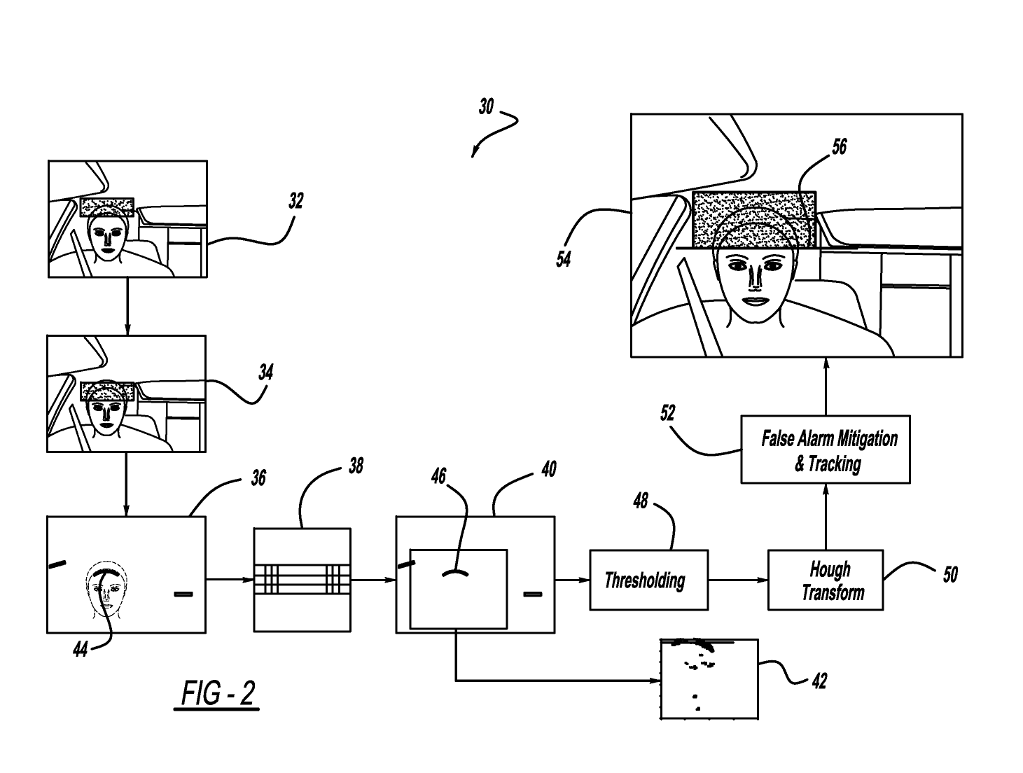

FIG. 2 is a flow chart diagram 30 showing a process and algorithm used in the controller 28 for identifying the sun-shade line 22 using an active detection method as described in the '573 application. Subsequent image frames 32 and 34 at times k and k−1 are provided by the camera 26 as images of the vehicle driver 12. The algorithm subtracts the subsequent image frames to provide a difference image 36 that defines areas of motion from frame to frame, where the subtraction provided by the difference image 36 removes those parts of the subsequent images that are stationary. The difference image 36 is then filtered by an expected motion filter 38, such as a line detection filter, to enhance the expected motion from the controlled sun blocker 18 and remove the un-expected motion, such as motion from the vehicle driver 12 in the horizontal direction, to generate a filtered response image 40. More specifically, the filter 38 filters the difference image 36 to remove those parts of the subsequent images that are in the difference image 36 as a result of the driver 12 moving in the horizontal direction, which could not be the sun-shade line 22. As the sun-shade line 22 moves in a vertical direction on the face of the driver 12 from image frame to image frame, the difference image 36 from one point in time to the next point in time will show a horizontal band 44 that identifies the location where the sub-shade line 22 is and used to be from one image to the next. The band 44 is not filtered by the filter 38 because it is a result of vertical motion and shows up as a strip 46 in the filtered response image 40.

If the sun-shade line 22 is moving downward from one frame to the next, then the band 44 will create a negative difference in the filter response image 40 and if the sun-shade line 22 is moving upward from one frame to the next, then that band 44 will create a positive difference in the filtered response image 40. If the sun-shade line 22 moves downward from one image frame to the next, then the filter response image 40 is multiplied by a negative one to change the negative band 44 to a positive band 44 that is of a light shade in the filter response image 40 that can be detected. The light regions in the difference image 36 and the filter response image 40 are shown dark in FIG. 2 only for the sake of clarity. A graphical representation 42 of the filter response image 40 can be produced from the filter response image 40 that identifies the lighter regions in the filter response image 40 in a pixel format.

Generally, other vertical motions in the images from one frame to the next frame will include other lighter portions that are not the sun-shade line 22. Known technology in the art allows cameras to detect the face region of the vehicle driver 12. The cropped face region of the filter response image 40 is thus sent to a thresholding box 48 that removes the portions of the filter response image 40 that do not exceed a predetermined intensity threshold to remove at least some of those non-sun-shade line portions. As a result of the threshold process, the threshold filter response image should mostly only include the strip 46 in the filtered response image 40 identifying the movement of the sun-shade line 22.

The threshold filter response image is then sent to a Hough transform 50, discussed in more detail below, that identifies areas in the filter response image that form a line. Once lines are identified in the threshold filter response image, the image is sent to a false alarm mitigation and pixel tracking box 52 that identifies false sun-shade lines, such as short lines, in the filter response image 40 that cannot be the sun-shade line 22. If the filter response gets through the false alarm mitigation and tracking, then the remaining line identified by the Hough transform 50 is the sun-shade line as shown by line 56 in a resulting image 54. The false alarm mitigation and tracking eliminates short line segments, maintains the temporal smoothing of the detected line's position orientation between neighboring frames using tracking techniques, such as Kalman filtering, particle filtering, etc., and tracks the specific motion pattern from the sun blocker's motion.

The Hough transform 50 is a technique for identifying lines in the filter response image 40. The algorithm parameterizes the lines in the image domain with two parameters, where parameter ρ represents the distance between a line and an origin and θ is the angle of the line, as shown in FIG. 3, where reference numeral 60 identifies the line. From this analysis ρᵢ=x cos θᵢ+y sin θᵢ. This relationship of the parameters is transferred to the Hough domain, as shown by the graph in FIG. 4, where θ is the horizontal axis and ρ is the vertical axis. Using the same analysis, a fixed point (x,y) corresponds to a sine curve 62 in the Hough domain. The Hough transform finds the peaks in the Hough domain by applying a threshold where the value of the peaks represents the number of points on the line.

Known technology in the art allows cameras to detect the eyes 24 of the vehicle driver 12 and by combining driver eye detection with the algorithm for detecting the sun-shade line 22 discussed above it can be determined whether that line is below the driver's eyes. If the sun-shade line 22 is not below the driver's eyes 24, then the controller 28 can adjust the blocker 18 to the appropriate location.

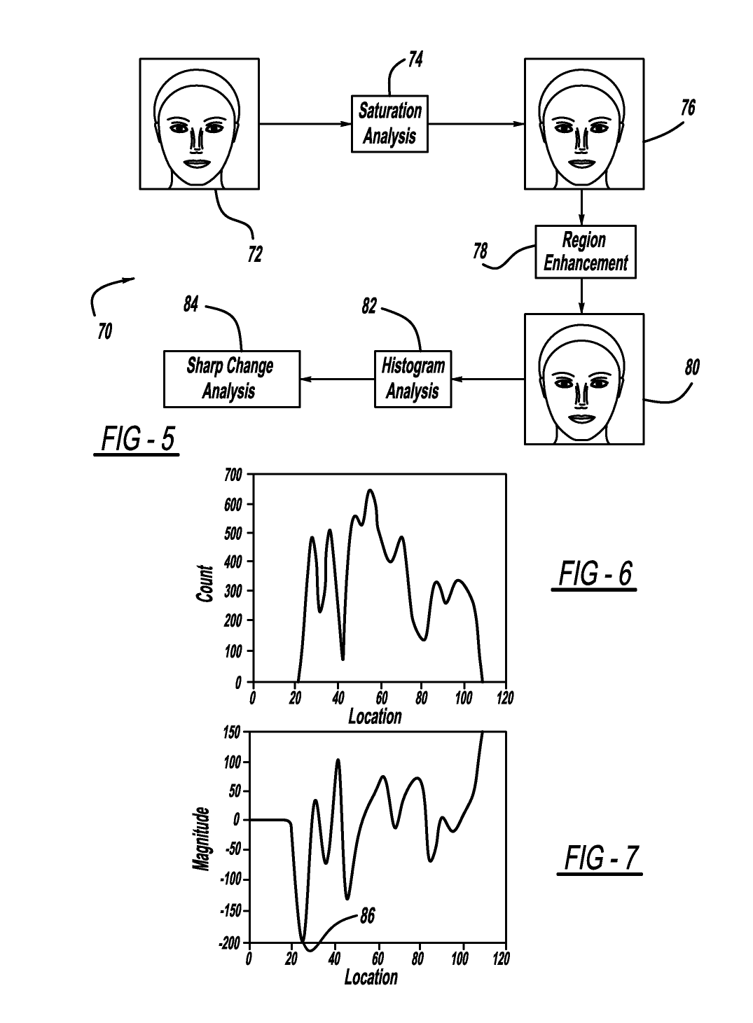

In another embodiment, the sun-shade line 22 is detected using a saturation-based approach. FIG. 5 is a flow chart diagram 70 showing a process for detecting the sun-shade line 22 in this manner. The process first generates a detected image 72 of the face of the driver 12 using, for example, the camera 26, although other detection techniques can be employed. Once the driver's face is detected and imaged, then the algorithm performs a saturation analysis at box 74 to determine areas within the image 72 that are saturated, i.e., washed out by light. The saturation analysis can be performed by any suitable process. In one non-limiting example, the algorithm looks at each pixel in the image 72 and determines whether that pixel exceeds a predetermined brightness threshold, which means the pixel is saturated. From the saturation analysis, a saturation image 76 is generated that includes a bright dot for each pixel that exceeds the threshold and a dark dot for each pixel that does not exceed the threshold. Because the saturation analysis uses a binary pixel-by-pixel analysis, the image 76 can look unsmooth or noisy. Therefore, the algorithm performs a region enhancement at box 78 that applies morphology techniques, such as erosion and dilation methods, to the saturation image 76 to remove rough edges, noise and isolated dots in the image 76. The region enhancement filtering process provides an enhanced image 80 from which the sun-shade line 22 can be identified. Although the images 72, 76 and 80 are depicted the same in FIG. 5, the actual images in a working application would look different consistent with the discussion herein.

The sun-shade line 22 is determined using a histogram analysis of the image 80 at box 82. The histogram analysis counts the number of white or bright dots in each row of dots in the image 80. A counting of the white dots in each row is shown in one example by the graph in FIG. 6, where the horizontal axis represents the location in the image or the horizontal row, and the vertical axis is the number of counted white dots. The peaks in the graph of FIG. 6 represent more white dots on a particular row. Further, the histogram analysis applies a smoothing filter, such as a Gaussian filter, to the count so that a smooth graph line is provided instead of a line with line brakes. Once the algorithm has the graph shown in FIG. 6, then it performs a sharp change analysis on the graph to determine where the sun-shade line 22 is located. Particularly, the most distinct or sharpest change between a row that includes the most black dots and a row that includes the most white dots, where the image goes from shade to saturation, represents the sun-shade line 22 and provides the largest negative number. FIG. 7 is a graph with image location on the horizontal axis and transition on the vertical axis where location 86 represents the sharpest change from black dots to white dots in the graph of FIG. 6. In one non-limiting embodiment, a differential filter is used on the graph line in FIG. 6 to provide the sharp change analysis to generate the graph line shown on FIG. 7.

The techniques for determining the location of the sun-shade line 22 discussed above that uses active detection and saturation-based detection are estimation processes that may determine that the sun-shade of line 22 is at different locations. According to another embodiment, a technique for determining the location of the sun-shade line 22 uses both the active detection and the saturation-based methods to determine location of the sun-shade line 22. This technique combines multiple observations from multiple detection methods to determine a signal value using a proposed time-series analysis method with consideration of observation consistency. If the two methods determine that the sun-shade line 22 is at the same or nearly the same location, then that is the determined location of the sun-shade line 22, and if the two methods determine that the sun-shade line 22 are at significantly different locations, then a predicted estimation can be used to determine the location of the sun-shade line 22.

The proposed technique extends the traditional Kalman Filtering by taking account of instant observation consistency. A state transition identifies the location Mₜ₋₁ of the sun-shade line 22 at one period in time relative to the location Mₜ of the sun-shade line 22 at a next or subsequent period in time, where the state transition of model parameters of the sun-shade line location M can be defined as:

Mₜ=f(Mₜ₋₁)+n (1)

The function f(Mₜ₋₁) is a state transition model that predicts the location of the sun-shade line 22 for future observations, t is the current time period, t−1 is the previous time period and n is noise.

An observation O₁ is a detection result from the first detection method of the model parameters of the sun-shade line location M for the saturation-based method, defined as:

O_{1,t}=g₁(M₁)+m (2)

Where gⱼ is an observation function that describes the relationship between state M and the i^{th} observation, and m is noise.

An observation O₂ is a detection result from the second detection method of the model parameters of the sun-shade line location M for the active detection method, defined as:

O_{2,t}=g₂(M₁)+m (3)

In this particular embodiment f(x)=x, g₁(x)=x, and g₂(x)=x.

An observation consistency value α is defined as the difference of the estimated model parameters of the location M of the sun-shade line 22 from different observations, namely, the saturation-based operation and the active detection observation. The observation consistency value α determines how much weight is given to the observations and the model prediction f(Mₜ₋₁) of the location of the sun-shade line 22. If the estimations from the instant observations O_{1,t} and O_{2,t} are consistent, i.e., nearly the same, then the algorithm determines that the estimations of the model parameters of the location of the sun-shade line 22 for the observations can be trusted more than the model prediction f(Mₜ₋₁), and if the estimations are not consistent, or are missing, then the algorithm puts less trust in the observations O_{1,t} and O_{2,t} and more trust in the model prediction f(Mₜ₋₁). This analysis is shown by equation (4) below.

Mₜ=f(Mₜ₋₁)+α(mean(gᵢ⁻¹(O_{i,t}))−f(Mₜ₋₁)) (4)

In this particular embodiment α=e^{(o}^{_{1,t}}^{-o}^{_{2,t}}^{)2/σ}^{²}.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining the location of a sun-shade line on an object using a saturation-based approach, said method comprising:
providing a detected image of the object;
performing a saturation analysis on the detected image to generate a binary saturation image that includes bright dots and dark dots;
performing a region enhancement on the saturation image to filter the saturation image and generate a filtered saturation image;
performing a histogram analysis on the filtered saturation image to identify a count of the bright dots on a row-by-row basis in the image; and
performing a sharp change analysis on results from the histogram analysis to identify the largest transition from a row with dark dots to a row with bright dots that defines the sun-shade line.

2. The method according to claim 1 wherein providing a detected image includes using a camera.

3. The method according to claim 1 wherein performing a saturation analysis includes comparing each pixel in the detected image to a brightness threshold.

4. The method according to claim 1 wherein performing the sharp change analysis includes using a differential filter.

5. The method according to claim 1 wherein the object is a vehicle driver.

6. The method according to claim 5 further comprising positioning a sun blocker in response to the identified position of the sun-shade line so that eyes of the vehicle driver are within a shadow caused by the sun blocker.

7. The method according to claim 1 further comprising determining the location of the sun-shade line using an active detection approach that is different than the saturation-based approach, wherein the saturation-based approach and the active detection approach are combined to determine the location of the sun-shade line.

8. The method according to claim 7 wherein the location of the sun-shade line is determined based on a weighting between the combined estimation approaches and a predicted location of the sun-shade line, where the weighting is determined by a consistency factor that increases as the determination of the location of the sun-shade line by the saturation-based approach and the active detection approach becomes closer, where the predicted location of the sun-shade line becomes less important, and decreases as the determination of the location of the sun-shade line by the saturation-based approach and the active detection approach becomes farther apart, where the predicted location of the sun-shade line becomes more important.

9. A method for determining the location of a sun-shade line on a vehicle driver using a saturation-based approach, said method comprising:
providing a detected image of the vehicle driver using a camera;
performing a saturation analysis on the detected image to generate a binary saturation image that includes bright dots and dark dots, wherein the saturation analysis includes comparing each pixel in the detected image to a brightness threshold;
performing a region enhancement on the saturation image to filter the saturation image and generate a filtered saturation image;
performing a histogram analysis on the filtered saturation image to generate a graph that identifies a count of the bright dots on a row-by-row basis in the image; and
performing a sharp change analysis on the graph using a differential filter to identify a most negative location in the graph that is the largest transition from a row with black dots to a row with bright dots to identify the sun-shade line.

10. The method according to claim 9 further comprising positioning a sun blocker in response to the identified position of the sun-shade line so that eyes of the vehicle driver are within a shadow caused by the sun blocker.

11. The method according to claim 9 further comprising determining the location of the sun-shade line using an active detection approach that is different than the saturation-based approach, wherein the saturation-based approach and the active detection approach are combined to determine the location of the sun-shade line.

12. The method according to claim 11 wherein the location of the sun-shade line is determined based on a weighting between the combined estimation approaches and a predicted location of the sun-shade line, where the weighting is determined by a consistency factor that increases as the determination of the location of the sun-shade line by the saturation-based approach and the active detection approach becomes closer, where the predicted location of the sun-shade line becomes less important, and decreases as the determination of the location of the sun-shade line by the saturation-based approach and the active detection approach becomes farther apart, where the predicted location of the sun-shade line becomes more important.

13. A system for determining the location of a sun-shade line on a vehicle driver using a saturation-based approach, said system comprising:
a camera for providing a detected image of the driver;
means for performing a saturation analysis on the detected image to generate a binary saturation image that includes bright dots and dark dots;
means for performing a region enhancement on the saturation image to filter the saturation image and generate a filtered saturation image;
means for performing a histogram analysis on the filtered saturation image to identify a count of the bright dots on a row-by-row basis in the image; and
means for performing a sharp change analysis on results from the histogram analysis to identify the largest transition from a row with dark dots to a row with bright dots that defines the sun-shade line.

14. The system according to claim 13 wherein the means for performing a saturation analysis compares each pixel in the detected image to a brightness threshold.

15. The system according to claim 13 wherein the means for performing the sharp change analysis uses a differential filter.

16. The system according to claim 13 further comprising means for positioning a sun blocker in response to the identified position of the sun-shade line so that eyes of the vehicle driver are within a shadow caused by the sun blocker.

17. The system according to claim 13 further comprising means for determining the location of the sun-shade line using an active detection approach that is different than the saturation-based approach, and means for combining the saturation-based approach and the active detection approach as a combined estimation approach that determines the location of the sun-shade line.

18. The system according to claim 17 wherein the means for combining the saturation-based approach and the active detection approach to determine the location of the sun-shade line is based on a weighting between the combined estimation approach and a predicted location of the sun-shade line, where the weighting is determined by a consistency factor that increases as the determination of the location of the sun-shade line by the saturation-based approach and the active detection approach becomes closer, where the predicted location of the sun-shade line becomes less important, and decreases as the determination of the location of the sun-shade line by the saturation-based approach and the active detection approach becomes farther apart, where the predicted location of the sun-shade line becomes more important.

19. A method for determining the location of a line on an object, said method comprising:
using a saturation-based approach that includes:
providing a detected image of the object;
performing a saturation analysis on the detected image to generate a binary saturation image that includes bright dots and dark dots;
performing a region enhancement on the saturation image to filter the saturation image and generate a filtered saturation image;
performing a histogram analysis on the filtered saturation image to identify a count of the bright dots on a row-by-row basis in the image;
performing a sharp change analysis on results from the histogram analysis to identify the largest transition from a row with dark dots to a row with bright dots that defines the line; and
using an active detection approach that is different than the saturation-based approach, wherein the saturation-based approach and the active detection approach are combined to determine the location of the line.

20. The method according to claim 19 wherein the location of the line is determined based on a weighting between the combined estimation approaches and a predicted location of the line, where the weighting is determined by a consistency factor that increases as the determination of the location of the line by the saturation-based approach and the active detection approach becomes closer, where the predicted location of the line becomes less important, and decreases as the determination of the location of the line by the saturation-based approach and the active detection approach becomes farther apart, where the predicted location of the line becomes more important.
